(19) United States
(12) Patent Application Publication
(10) Pub. No.: US 2019/0019239 A1
(43) Pub. Date: Jan. 17, 2019

(54) ARCHITECTURE, SYSTEM AND METHOD FOR USERS TO ORDER ITEMS FOR DELIVERY DURING TRAVEL EVENTS

(71) Applicant: Somar Concepts, San Dimas, CA (US)

(72) Inventors: Rafael Ramos, San Dimas, CA (US); Steve Ramos, Fontana, CA (US)

(21) Appl. No.: 16/033,627

(22) Filed: Jul. 12, 2018

Related U.S. Application Data
(60) Provisional application No. 62/531,868, filed on Jul. 12, 2017.

(51) Int. Cl. G06Q 30/06; G06Q 50/14; G06Q 10/02

(52) U.S. Cl. CPC G06Q 30/0633; G06Q 30/0631; G06Q 10/02; G06Q 30/0603; G06Q 50/14; G06Q 30/0643

(57) ABSTRACT

Embodiments of enabling ordering and delivery of items to a User on a carrier for a future travel event. Other embodiments may be described and claimed.

### TECHNICAL FIELD

Various embodiments described herein relate generally to enabling users to order items for later delivery.

### BACKGROUND INFORMATION

It may be desirable to enable a User to order items for delivery during a travel event, the present invention enables such deliveries.

### BRIEF DESCRIPTION OF THE DRAWINGS

FIG. 1 is a block diagram of travel event order delivery (TEOD) architecture according to various embodiments.

FIG. 2A is a diagram of communications between devices and systems in a TEOD architecture according to various embodiments.

FIG. 2B is a diagram of communications between devices and systems in a TEOD architecture according to various embodiments.

FIG. 2C is a diagram of communications between devices and systems in a TEOD architecture according to various embodiments.

FIG. 3A is a block diagram of TOED architecture providing a user order page to a user device according to various embodiments.

FIG. 3B is a block diagram of TOED architecture providing a user travel event identification page to a user device according to various embodiments.

FIG. 3C is a block diagram of TOED architecture providing a delivery agent order delivery page to a delivery agent/cart system (DACS) according to various embodiments.

FIG. 4 is a block diagram of an order processing system according to various embodiments.

FIG. 5 is a flow diagram illustrating several methods according to various embodiments.

FIG. 6A is a block diagram of an article according to various embodiments.

FIG. 6B is a block diagram of an article according to various embodiments.

### DETAILED DESCRIPTION

During travel events, travelers or passengers may be given the opportunity to purchase items, for example a passenger on an airline flight may have the option to purchase food items during the flight. The food items may be fresh/perishable or boxed, shelf stable items. Generally, some passengers are not able to purchase a desired item, in particular perishable items because limited quantities of such items are loaded on the plane to reduce waste and weight. The present invention overcomes such limitations by enabling passengers or travelers termed “Users” to order items including perishable food items for a future travel event such as an airline flight. In an embodiment, users may also be able to order non-food items for delivery during a travel event, for example blankets, pillows, or other comfort aids that are also in limited supply on airline flights or other common carriers (buses, trains, ferries, cruise ships, and other travel providers).

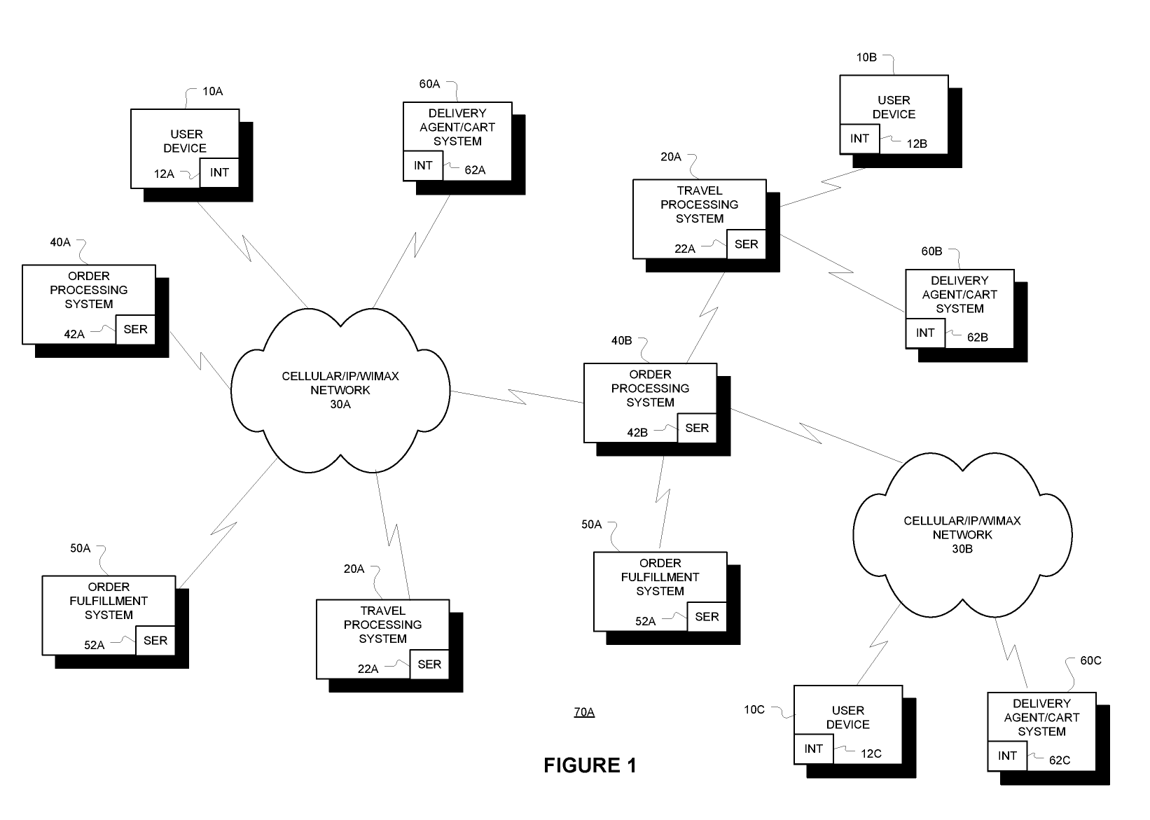

FIG. 1 is a block diagram of a travel event order delivery (TEOD) architecture 70A according to various embodiments. As shown in FIG. 1, architecture 70A may include one or more order processing system (OPS) 40A, 40B, several networked User (passenger or travelers in an embodiment) devices (UD) 10A-C, one or more order fulfillment system (OFS) 50A, 50B, one or more travel processing system (TPS) 20A, 20B, several networked delivery agent/cart system (DACS) 60A-B, and wireless or wired networks 30A, 30B. In an embodiment, an order processing system (OPS) 40A may be a multi-order processing system that may communicate items for sale and items ordered to User devices 10A-C and OFS 50A-B via a wired or wireless connection. In an embodiment, a OPS 40A-B may be part of a TPS 20A. Further, the OFS 50A-B may also be part of a OPS 40A-B or a TPS 20A.

An order fulfillment system (OFS) 50A-B may be a system that can receive orders and enable such orders to be delivered to a carrier involved with a travel event for a User, such as a caterer delivering food items to an airplane that the User is scheduled to board where their travel event is a flight on the airplane. A travel processing system 20A-B may be a system that enables a User to select, book, or ticket a travel event including reserving or paying for a seat on an airplane flight. A User device may be any electronic device capable of communicating with the OPS 40A-B via a webpage, device specific application, operating system specific application, or other application or application program interface (API). Such user device 10A-C may include a smart watch, mobile phone, tablet, laptop, desktop, or other such device.

Similarly, the delivery agent/cart system DACS may be may be any electronic device capable of communicating with the OPS 40A-B or TPS 20A-B (in an embodiment) via a webpage, device specific application, operating system specific application, or other application or application program interface (API). Such a delivery agent/cart system DACS 60A-B may include a smart watch, mobile phone, tablet, laptop, desktop, or other such device. In an embodiment, the DACS 60A-B may be operated by an authorized employee of the OPS 40A-B (such as the catering company) or the carrier (such a flight attendant on an airline flight).

A OPS 40A, 40B, TPS 20A, 20B, OFS 50A, 50B may each include a server 42A, 42B, 22A, 22B, 52A, 52B that may enable communication between themselves and other systems and devices of TOED 70A. A OPS 40A, 40B, TPS 20A, 20B, OFS 50A, 50B may employ an application specific integrated circuit (ASIC) (274 FIG. 7B) to transceive signals with one or more devices or systems of TOED 70A. A OPS 40A, 40B, TPS 20A, 20B, OFS 50A, 50B server 42A, 42B, 22A, 22B, 52A, 52B may be a webserver that communicates data that may be processed by a web browser application resident on a User device 10A-C or DACS 60A-B. In an embodiment, a OPS 40A, 40B, TPS 20A, 20B, OFS 50A, 50B server 42A, 42B, 22A, 22B, 52A, 52B may generate Hyper Text Markup Language (HTML) encoded data that a User device 10A-C or DACS 60A-B may process via a resident web browser.

In an embodiment, a OPS 40A, 40B, TPS 20A, 20B, OFS 50A, 50B server 42A, 42B, 22A, 22B, 52A, 52B may communicate data including order, user, travel event related data using other protocols including an application specific protocols. A User device 10A-C or DACS 60A-B or system OPS 40A, 40B, TPS 20A, 20B, OFS 50A, 50B may include a program to decode/encode the application specific protocol communications between themselves and another User device 10A-C or DACS 60A-B or system OPS 40A, 40B, TPS 20A, 20B, OFS 50A, 50B. As shown in FIG. 1, a UD 10A-C may be coupled to a OPS 40A, 40B or TPS 20A-B via a network 30A, 30B. A network 30A, 30B may be a local network or a network of networks. As shown, UD 10B may be coupled directly to a TPS 20A via a wired or wireless connection. Similarly, a DACS 60A-60B may be able to communicate directly or indirectly with a OPS 40A, 40B or TPS 20A-B via a network 30A, 30B or other device or system in an embodiment. Further, a OPS 40A, 40B may be able to communicate directly or indirectly with a TPS 20A-B via a network 30A, 30B or other device or system.

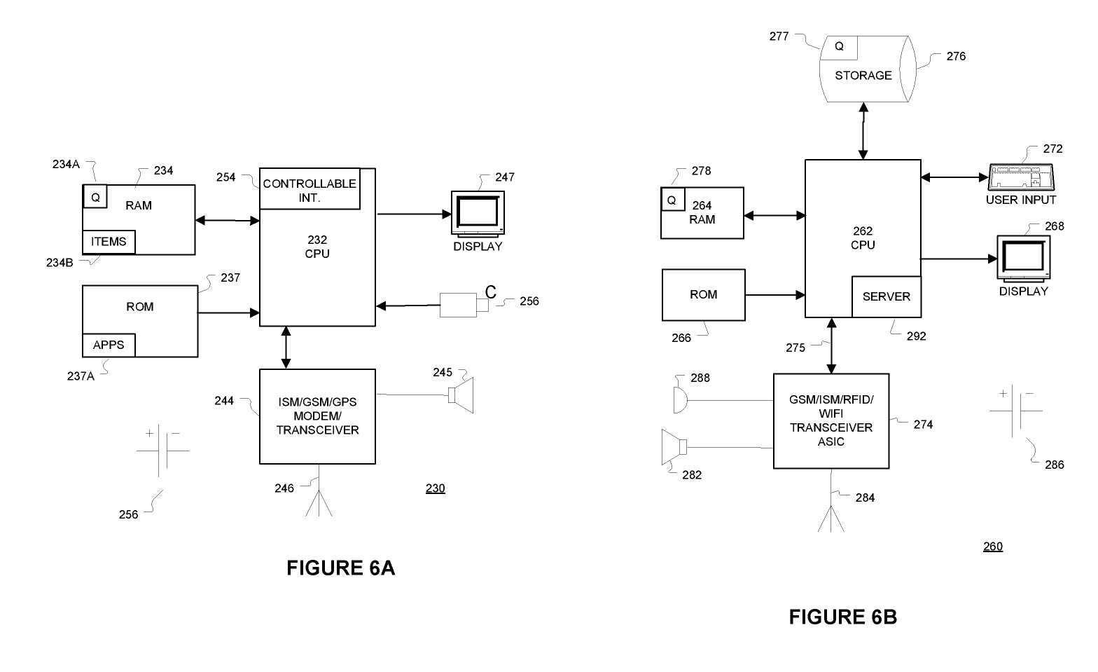

A network 30A, 30B may be a local network or a network of networks. A UD 10A-C and DACS 60A-60B may include an interface (network interface controller (NIC)) 12A-12C, 62A-62B that enables IP based communication with a OPS 40A, 40B, OFS 50A-B, or TPS 20A-B. The interface 12A-12C, 62A-62B may include a modem/transceiver 244 (244, FIG. 6A). The modem/transceiver 244 may include an application specific integrated circuit (ASIC). The network 30A, 30B may be a local network, a network of networks, or a worldwide network of networks, termed the “Internet”, cellular network, or WiMax networks. In an embodiment, a UD 10A-C or DACS 60A-60B interface 12A-12C, 62A-62B may communicate with a OPS 40A, 40B, OFS 50A-B, or TPS 20A-B via several networks. It is noted that in an embodiment, the networks 30A, 30B may be industrial, scientific and medical (ISM) radio bands, Groupe Spécial Mobile (GSM), Code-division multiple access (CDMA), time division multiple access (TDMA), mesh, and short messaging system (SMS) based network, WiMax, IP (wired or wireless network) such as 802.11a, b, g, n networks.

A network 30A, 30B may be a terrestrially based network or satellite based network, or combination thereof. Each UD 10A-C or DACS 60A-60B may include an interface 12A-12C, 62A-62B that enables communications between a UD 10A-C or DACS 60A-60B and a OPS 40A, 40B, OFS 50A-B, or TPS 20A-B via a network 30A, 30B directly or indirectly. In an embodiment, a UD 10A-C or DACS 60A-60B may be cellular device such an iPhone® or other smartphone, tablet device including an iPad®, laptop, tablet, desktop, or other electronic device capable of communicating via one or more wired or wireless protocols. In an embodiment, a OPS 40A, 40B, OFS 50A-B, or TPS 20A-B may be an electronic device 260 that may include a module 274 to communicate signals with a MD 12A-12E. A OPS 40A, 40B, OFS 50A-B, or TPS 20A-B may also include a server 42A, 42B, 22A, 22B, 52A, 52B (292, FIG. 6B).

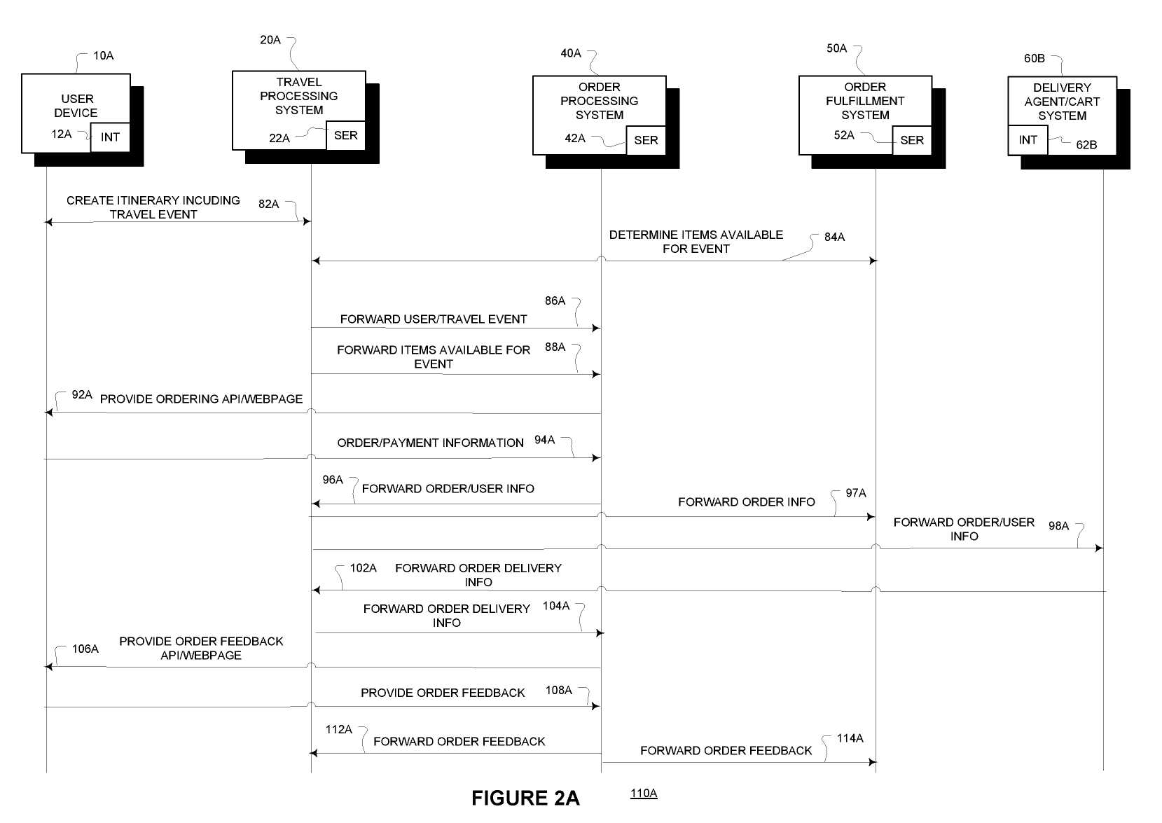

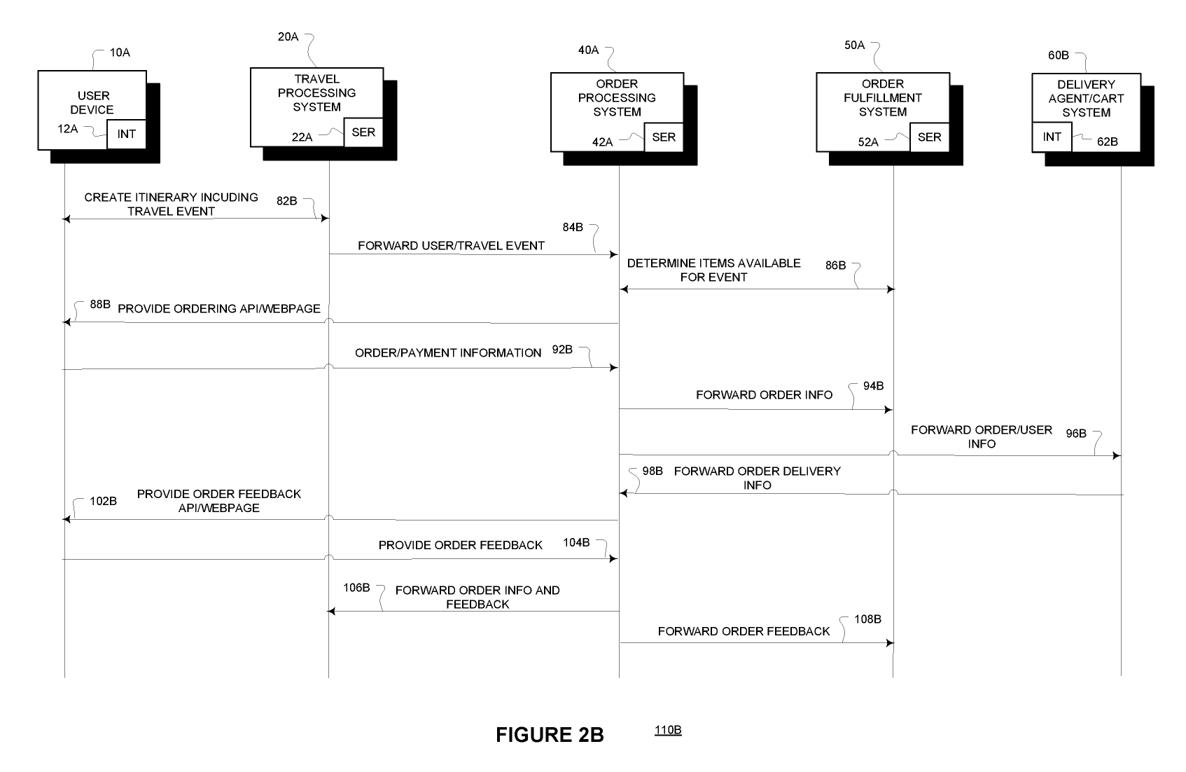

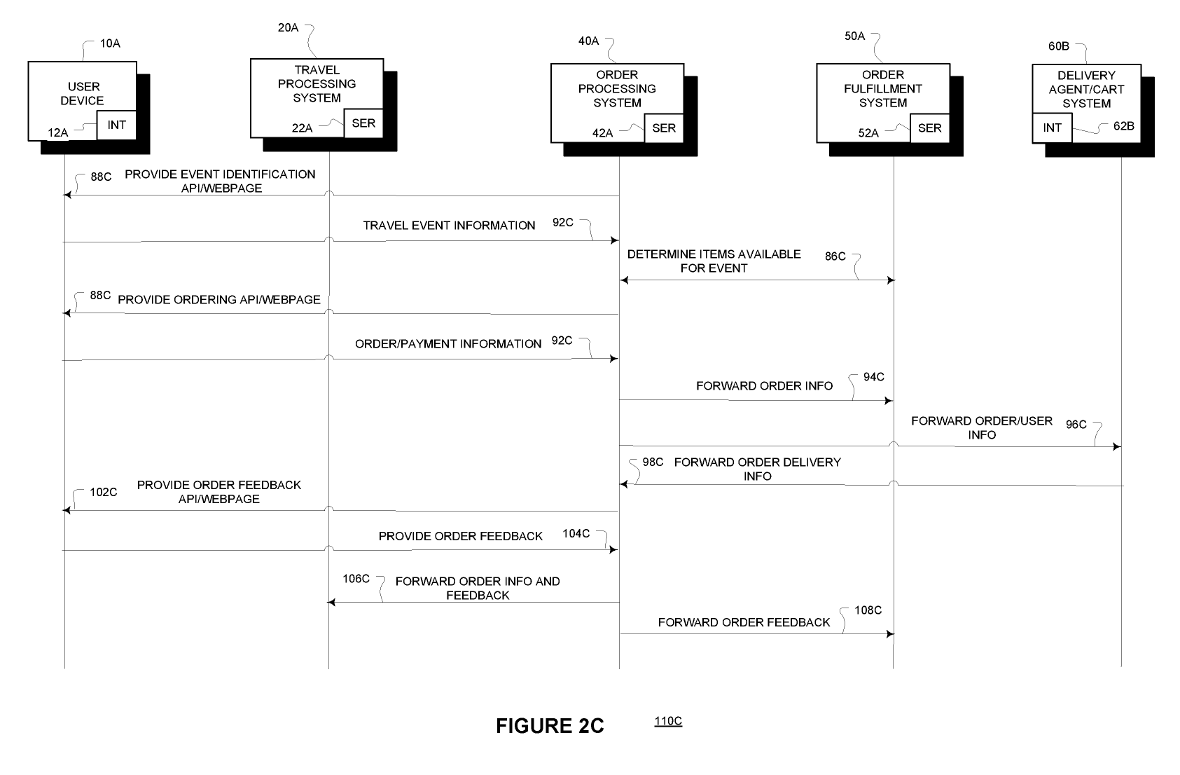

FIGS. 2A-2C are diagrams of communications between devices and systems in a TEOD architecture according to various embodiments. In an embodiment, systems OPS 40A, 40B, OFS 50A-B, or TPS 20A-B may have different roles due to User or passenger security and item delivery security and limitations based on the related travel event. In one embodiment, a TPS 20A-B may control the operation of other system components and the flow of data therebetween as detailed in FIG. 2A. As shown in FIG. 2A, a User via a UD 10A, may communicate with a TPS 20A-B to create a future travel event (communication 82A). As noted, the TPS 20A-B may be operated by a direct travel event provider such as an airline or a 3^{rd} party such a website providing access to travel events. Once, a User creates a travel event, a TPS 20A may communicate with an OFS 50A to get a real time or batched list of items that a User may order to be delivered during their travel event.

The OFS 50A for example may be a caterer that allows limited food items for travel events based on their current or expected future inventory or the carrier's stated allowed items, or combination thereof. The TPS 20A may only provide the time, date, and flight number for the future travel event to the OFS 50A to protect the privacy of a User 136. As noted, a OPS 50A may provide in real time or periodically a list of items available for delivery on a particular travel event (such as an airline flight). In an embodiment, a TPS 20A may forward such item list in real time or periodically to a an OPS 40A (communication 86A).

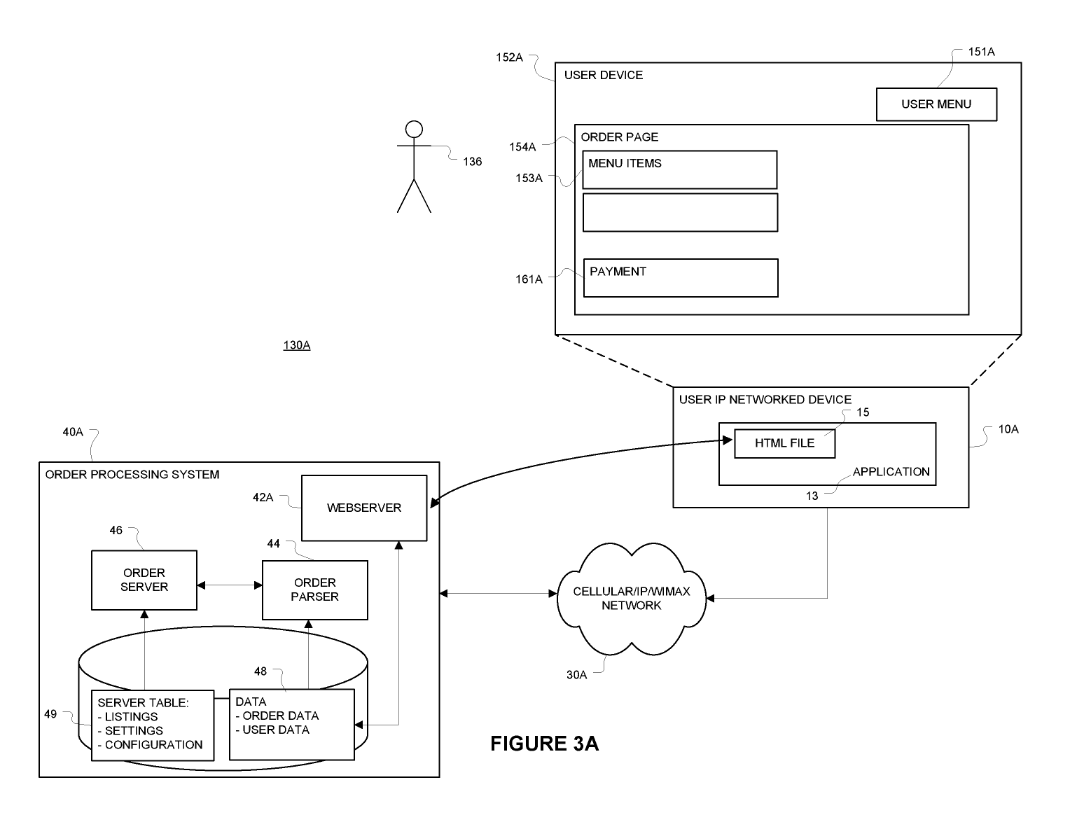

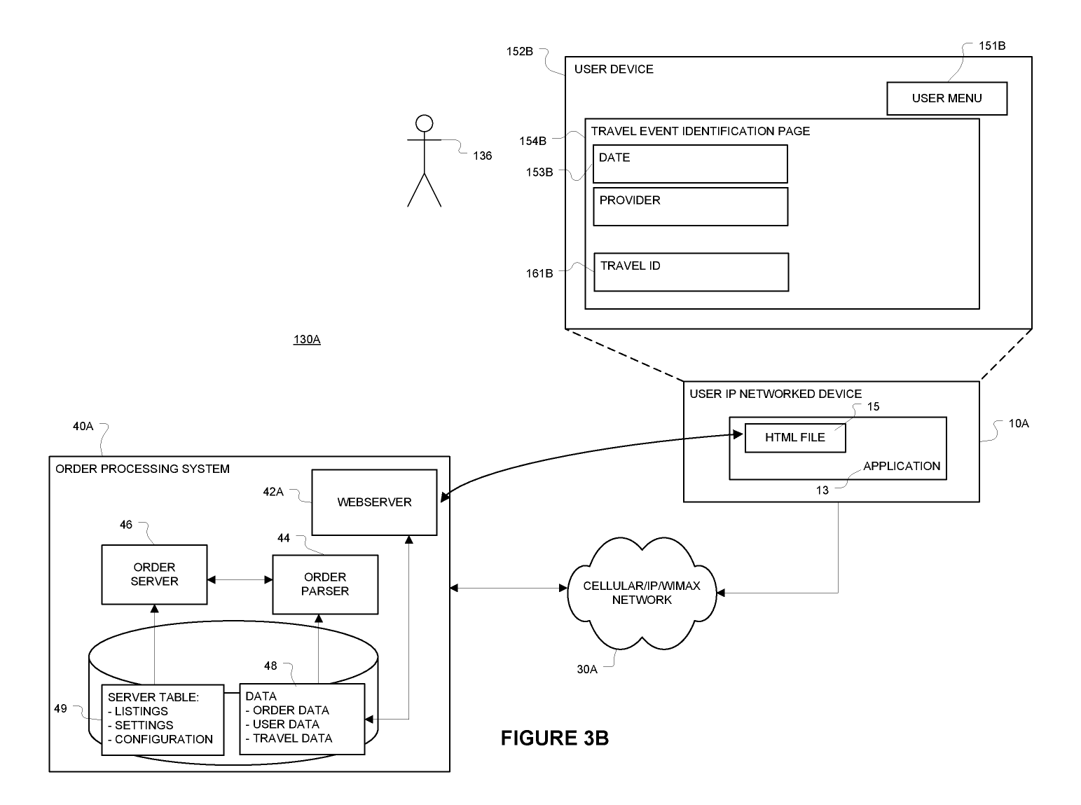

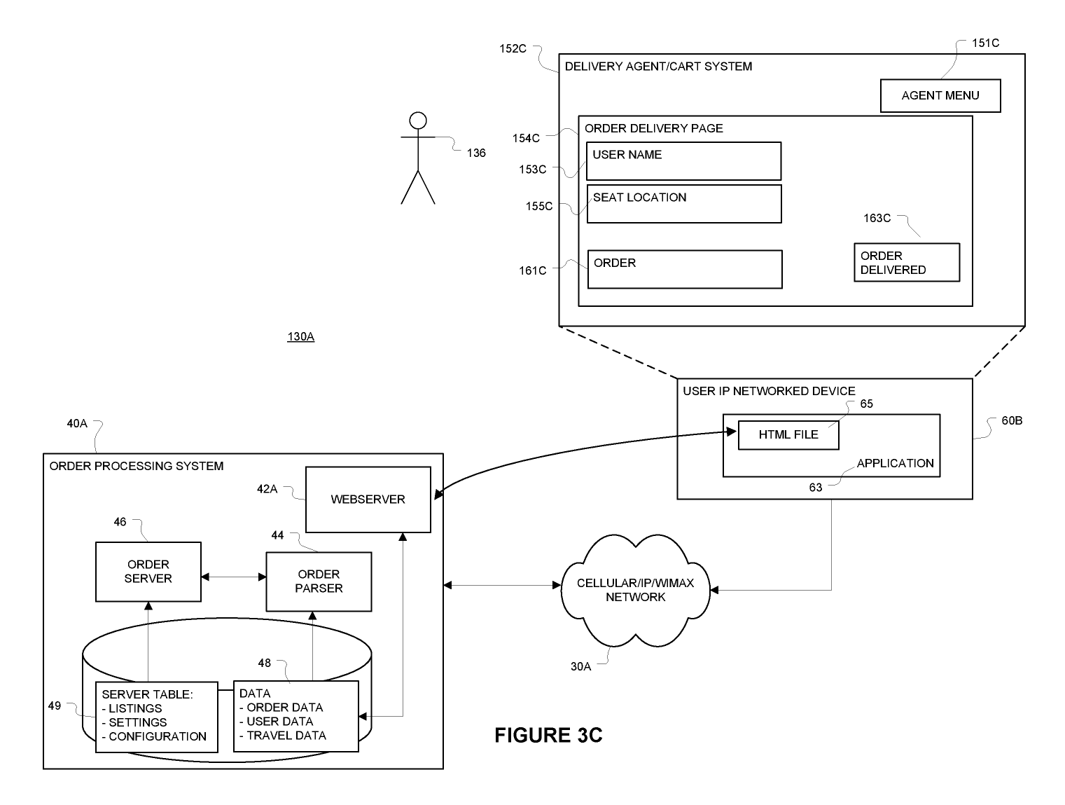

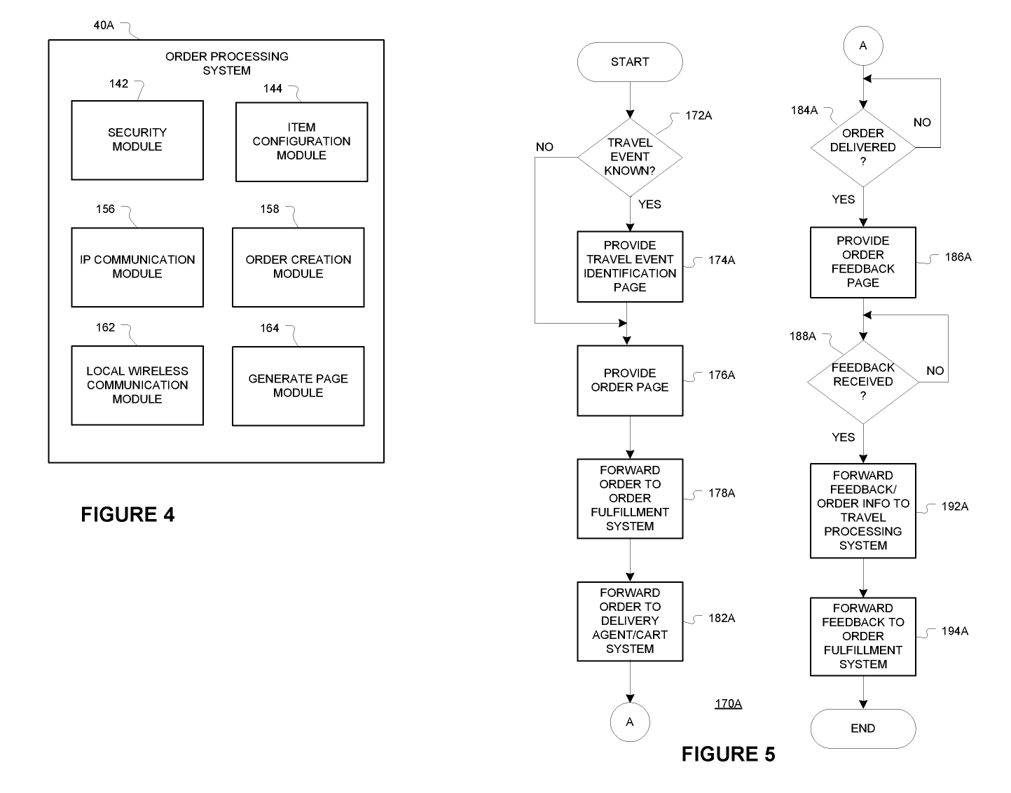

A OPS 40A may store the item list in a database 48 (FIG. 3A) and generate an order page (152A, FIG. 3A) to be communicated to a User device 10A directly or indirectly via a TPS 20A (communication 92A). A TPS 20A may also forward User related travel event information (communication 86A) to a OPS 40A. The OPS 40A may store such information in a database 48 and use such information to communicate an order with a TPS 20A (communication 96A). A OPS 40A may employ the algorithm 170A shown in FIG. 5 and include the modules shown in FIG. 4 to process orders. In an embodiment, an OPS 40A may determine whether a TPS 20A or other resource has provided the travel event where items are to be delivered (activity 172A). In FIGS. 2A and 2B, the TPS 20A provides such information. In FIG. 2C, a User 136 via a UD 10A is provided with a travel identification page (activity 174A) shown as shown in FIG. 3B so a User may identify their travel event. As shown in FIG. 3B, the travel event identification page 154B may request the travel date and provider (carrier) 153B and a travel ID 161B such a record locator code.

Once the OPS 40A has determined or been provided the User's travel event, it can then generate an Order page (activity 176A). As noted in FIG. 2A, a TPS 20A may provide a list of items available for delivery during the travel event. As shown in FIGS. 2B and 2C, an OPS 40A may communicate with a OFS 50A to determine the real time or batched item list based on the travel event. An OPS 40A may then use the item list to generate the order page 152A shown in FIG. 3A. As shown in FIG. 3A, the order page 152A includes a list of items 153A, payment option 161A, and User menu 151A. The User menu 151A may enable a user 136 to view current or past orders and see upcoming travel events.

Once a User completes the order page, an OPS 40A may forward the order with User information to a TPS 20A (communication 96A) as shown in FIG. 2A. The TPS 20A may then communicate the order to the OFS 50A and a DACS 60B (communications 97A and 98A and activities 178A and 182A of FIG. 5). Such a configuration may be required due to security protocols at the OPS 50A and for the DACS 60B. In another embodiment, an OPS 40A may communicate the order to the OFS 50A and a DACS 60B directly (communications 94B and 96B in FIG. 2B and communications 94C and 96C in FIG. 2C).

FIG. 3C shows an delivery agent order delivery page 152C that may be displayed on a delivery agent/cart system (DACS) 60B according to various embodiments. As shown in FIG. 3C, the order delivery page 152C may include the User's name 153C, seat location (if known) 155C, order details 161C, and an order delivered icon 163C. In an embodiment, a TPS 20A or other system may provide or update seat location to a DACS 60B in real time. A DACS 60B User 136 may select the Order delivered icon 163C once an order is delivered (activity 184A).

In an embodiment, the TPS 20A may receive the order delivery communication from a DACS and forward a notice to the OPS 40A (communications 102A, 104A of FIG. 2A). In another embodiment, the DACS 60B may communicate order delivery information directly to an OPS 40A (communications 98B, 98C of FIGS. 2B, 2C). A OPS 40A may then forward an order feedback page, text, E-mail or other communication to a UD 10A (communications 106A, 102B, 102C of FIGS. 2A-2C) (activity 186A). Once feedback is received (activity 188A), the feedback may be forwarded to the TPS 20A and OFS (activity 192A and 194A) (communications 112A, 114A FIG. 2A, 106B, 108B FIG. 2B, and 106C, 108C FIG. 2C).

FIG. 6A illustrates a block diagram of a device 230 that may be employed at least in part in a UD 10A-10C or DACS 60A-B in various embodiments. The device 230 may include a central processing unit (CPU) 232, a random access memory (RAM) 234, a read only memory (ROM) 237, a local wireless/GPS modem/transceiver 244, a display 247, a camera 256, a speaker 245, a rechargeable electrical storage element 256, and an antenna 246. The CPU 232 may include a control interface 254 including an IP type network controller interface (NIC). The RAM 234 may include a queue or table 248 where the queue 248 may be used to store web pages, applications, or APIs. The RAM 234 may also include program, algorithm, and system data and instructions. The rechargeable electrical storage element may be a battery or capacitor in an embodiment.

The modem/transceiver 244 may couple, in a well-known manner, the device 230 to a wired or wireless network 30A, 30B to enable communication with a OPS 40A-40D, TPS 20A-B, or OFS 50A-B. The modem/transceiver 244 may also be able to receive global positioning signals (GPS) and the CPU 232 may be able to convert the GPS signals to location data that may be stored in the RAM 234 and provided to a OPS 40A-40D, TPS 20A-B, or OFS 50A-B with a URL/URI request. The ROM 237 may store program instructions to be executed by the CPU 232 or control interface 254 (applications 237A). The applications 237A may include a web browser program or application. The RAM 234 may also be used to store program information, queues, databases, and overhead information.

FIG. 6B illustrates a block diagram of a device 260 that may be employed at least in part in a OPS 40A-40D, TPS 20A-B, or OFS 50A-B in various embodiments. The device 260 may include a central processing unit (CPU) 262, a random access memory (RAM) 264, a read only memory (ROM) 266, a display 268, a user input device 272, a transceiver application specific integrated circuit (ASIC) 274, a microphone 288, a speaker 282, storage 276, electrical energy storage unit 286, and an antenna 284. The CPU 262 may include a server 292. The RAM 264 may include a queue 278 where the queue 278 may store reference order content data. The server 292 may function as the web-server/e-mail processor 42A, 42B of the OPS 40A-40D, TPS 20A-B, or OFS 50A-B.

The ROM 266 is coupled to the CPU 262 and may store the program instructions to be executed by the CPU 262 and the server 292. The ROM 266 may include applications and instructions for the security module 142, item configuration module 144, IP communication module 156, order creation module 158, local wireless communication module 162, and generate page module 164 shown in FIG. 4. The RAM 264 may be coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear multimedia content.

The microphone 288 and speaker 282 may be incorporated into the device 260. The microphone 288 and speaker 282 may also be separated from the device 260. Received data may be transmitted to the CPU 262 via a serial bus 275 where the data may include messages, reference images, or pages received, messages, or web pages to be transmitted, or protocol information. The transceiver ASIC 274 may include an instruction set necessary to communicate messages or web pages, applications, APIs, and data via network 30A, 30B. The ASIC 274 may be coupled to the antenna 284 to communicate messages, content, or pages wireless. When a message is received by the transceiver ASIC 274, its corresponding data may be transferred to the CPU 262 via the serial bus 276. The data can include wireless protocol, overhead information, sensor, and pages to be processed by the device 260 in accordance with the methods described herein.

The rechargeable electrical storage element 286 may be a battery or capacitor in an embodiment. The storage 276 may be any digital storage medium and may be coupled to the CPU 262 and may store temporary program data, overhead information, and databases 48, 49.

Any of the components previously described can be implemented in a number of ways, including embodiments in software. Any of the components previously described can be implemented in a number of ways, including embodiments in software. Thus, the devices 230, 260 elements including the RAM 234, ROM 237, CPU 232, transceiver 244, storage 276, CPU 262, RAM 264, ROM 266, and transceiver ASIC 274, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A travel event order processing method, including:
electronically receiving travel event information for a User;
determining a plurality of items available for purchase based on the receiving travel event information;
electronically providing a list of a plurality of items available for purchase to the User;
electronically receiving a list of items of the plurality of items that the User wants to receive during the travel event; and
electronically forwarding the list of items that the User wants to receive during the travel event and User information to a travel event item provider.

2. The travel event order processing method of claim 1, wherein the travel event is an airline flight and the User is a passenger.

3. The travel event order processing method of claim 1, wherein at least one item of the plurality of items available for purchase is an edible item.

4. The travel event order processing method of claim 1, including electronically receiving travel event information for a User from a travel processing system.

5. The travel event order processing method of claim 1, including electronically receiving travel event information for a User from a User device.

6. The travel event order processing method of claim 1, including determining at an order fulfillment system a plurality of items available for purchase based on the receiving travel event information.

7. The travel event order processing method of claim 1, including determining at an order fulfillment system a plurality of items available for purchase based on the receiving travel event information and forwarding the plurality of items available for purchase to an order processing system.

8. The travel event order processing method of claim 4, including determining at an order fulfillment system a plurality of items available for purchase based on the receiving travel event information and forwarding the plurality of items available for purchase to the travel processing system.

9. The travel event order processing method of claim 1, including electronically receiving a list of items of the plurality of items that the User wants to receive during the travel event from a User device.

10. The travel event order processing method of claim 7, including electronically forwarding the list of items that the User wants to receive during the travel event and User information to an order processing system.

11. A travel event order processing architecture, including:
electronically receiving travel event information for a User at an order processing system;
determining a plurality of items available for purchase based on the receiving travel event information at an order fulfillment system;
the order processing system electronically providing a list of a plurality of items available for purchase to the User;
the order processing system electronically receiving a list of items of the plurality of items that the User wants to receive during the travel event; and
the order processing system electronically forwarding the list of items that the User wants to receive during the travel event and User information to a travel event item provider.

12. The travel event order processing architecture of claim 11, wherein the travel event is an airline flight and the User is a passenger.

13. The travel event order processing architecture of claim 11, wherein at least one item of the plurality of items available for purchase is an edible item.

14. The travel event order processing architecture of claim 11, including electronically receiving travel event information for a User at an order processing system from a travel processing system.

15. The travel event order processing architecture of claim 11, including electronically receiving travel event information for a User at an order processing system from a User device.

16. The travel event order processing architecture of claim 11, wherein at least one item of the plurality of items available for purchase is a perishable food item.

17. The travel event order processing architecture of claim 11, including determining at an order fulfillment system a plurality of items available for purchase based on the receiving travel event information and forwarding the plurality of items available for purchase to the order processing system.

18. The travel event order processing architecture of claim 14, including determining at an order fulfillment system a plurality of items available for purchase based on the receiving travel event information and forwarding the plurality of items available for purchase to the travel processing system.

19. The travel event order processing architecture of claim 11, including the order processing system electronically receiving a list of items of the plurality of items that the User wants to receive during the travel event from a User device.

20. The travel event order processing architecture of claim 17, including at the order fulfillment system electronically forwarding the list of items that the User wants to receive during the travel event and User information to the order processing system.
